(19) United States
(12) Patent Application Publication
(10) Pub. No.: US 2018/0217748 A1
(43) Pub. Date: Aug. 2, 2018

(54) ADAPTIVE USER INTERFACE BASED ON LEFT OR RIGHT HANDED MODE

(71) Applicant: INTERNATIONAL BUSINESS MACHINES CORPORATION, Armonk, NY (US)

(72) Inventors: Ying Cao, Beijing (CN); Zhi Chen, Beijing (CN); Jun Su, Beijing (CN); Yin Xia, Beijing (CN)

(21) Appl. No.: 15/718,073

(22) Filed: Sep. 28, 2017

Related U.S. Application Data
(63) Continuation of application No. 15/420,711, filed on Jan. 31, 2017.

(51) Int. Cl. G06F 3/0488; G06F 3/0484; G06F 3/041

(52) U.S. Cl. CPC G06F 3/04883; G06F 2203/04108; G06F 3/0416; G06F 3/04845

(57) ABSTRACT

Embodiments of the present invention disclose a method, computer system, and a computer program product for adapting a user interface (UI) with a touchscreen. The present invention may include receiving, from the touchscreen, an input from a finger. The present invention may also include determining an orientation of the finger based on the received input. The present invention may then include adapting the UI based on the determined orientation. The present invention may further include displaying the adapted UI on the touchscreen.

### BACKGROUND

The present invention relates generally to the field of computing, and more particularly to touch input detection.

As mobile device use continues to be integral in the daily life of many people, mobile devices adapt to provide an efficient user interface (UI) in the multitude of situations mobile devices are used. Mobile device UIs and functions may be adapted to suit landscape or portrait orientation of the mobile device, single-handed use, and so on to provide a consistent and efficient experience to a user.

### SUMMARY

Embodiments of the present invention disclose a method, computer system, and a computer program product for adapting a user interface (UI) with a touchscreen. The present invention may include receiving, from the touchscreen, an input from a finger. The present invention may also include determining an orientation of the finger based on the received input. The present invention may then include adapting the UI based on the determined orientation. The present invention may further include displaying the adapted UI on the touchscreen.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 depicts a top view example of single-handed operation of a mobile device using a left hand for interaction according to at least one embodiment;

FIG. 3 depicts a top view example of double-handed operation of a mobile device using a right hand for interaction according to at least one embodiment;

FIG. 4 depicts a side view of an angled single finger interaction with a touchscreen according to at least one embodiment;

FIG. 5 depicts a top view of finger orientation detection on a touchscreen according to at least one embodiment;

FIG. 6 is an operational flowchart illustrating a process for adapting user interfaces based on finger orientation according to at least one embodiment;

FIG. 7 is a block diagram of internal and external components of computers and servers depicted in FIG. 1 according to at least one embodiment;

FIG. 8 is a block diagram of an illustrative cloud computing environment including the computer system depicted in FIG. 1, in accordance with an embodiment of the present disclosure; and

FIG. 9 is a block diagram of functional layers of the illustrative cloud computing environment of FIG. 8, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As described previously, as mobile device use continues to be integral in the daily life of many people, mobile devices adapt to provide an efficient user interface (UI) in the multitude of situations mobile devices are used. Mobile device UIs and functions may be adapted to suit landscape or portrait orientation of the mobile device, single-handed use, and so on to provide a consistent and efficient experience to a user.

In the situation of single-hand interaction with a mobile device, adapting the UI displayed on a mobile device, as well as the detection of and response to interaction from the user, may be beneficial to provide an intuitive UI. Determining which hand (right or left) is used for interaction with the mobile device traditionally employs additional hardware, such as one or more cameras, scanners, proximity sensors, and so on. These additional sensors and parts may require bulkier phone designs which are aesthetically undesirable. Furthermore, the additional sensors create increased power demands, thereby impacting battery life and increased processing to, for example, capture images of the finger of a user and compare the captured images with existing data. Any additional sensors also increase costs and create additional points of failure in the mobile device.

Therefore, it may be advantageous to, among other things, provide a way to determine which hand is interacting with a mobile device that is lightweight and responsive by leveraging the touchscreen already integrated into the mobile device and adapting the UI accordingly.

The following described exemplary embodiments provide a system, method and program product for adapting a UI based on the hand used for interaction with a mobile device. As such, the present embodiment has the capacity to improve the technical field of touch input detection by using a self-capacitance touchscreen (or similar floating-capable technology) to determine if a left hand or a right hand is used for input and adapting the UI accordingly. More specifically, a mobile device using a self-capacitance touchscreen may be used to detect the presence of the portion of the user's finger that is not touching the touchscreen in addition to detecting the point where the fingertip touches the touchscreen. By detecting the angles of the finger with respect to the touchscreen, whether the left hand or the right hand is used may be determined. Thereafter, the UI may be adapted to suit operation by the left hand or right hand.

According to at least one embodiment, a self-capacitance touchscreen, Floating Touch™ (Floating touch and all Floating touch-based trademarks and logos are trademarks or registered trademarks of Sony Mobile Communications, Inc. and/or its affiliates) screen, or similar floating-capable technology may be used that can detect a finger that is not directly touching the screen (with or without additionally detecting the fingertip touching the screen) to provide data indicating the orientation of the user's finger. Such touchscreens may detect a finger within a threshold distance from the touchscreen with, in some cases, varying degrees of signal strength corresponding to different distances from the touchscreen. For example, a stronger signal may be generated from the touchscreen at a given screen coordinate for a portion of a finger that is closer to the screen than a portion of the finger that is farther away. A mobile device may use such a touchscreen without the aforementioned deficiencies accompanying additional sensors, as a touchscreen is already included in many mobile devices. Furthermore, less processing may be required versus comparing images of fingers, finger vein structure, or fingerprints to determine if the user's left hand or right hand is being used to interact with the touchscreen.

By using a self-capacitance touchscreen (i.e., floating-capable touchscreen), the angle of the finger in relation to the touchscreen may be determined. The self-capacitance touchscreen may be used to detect the angle of a finger in relation to the plane of the touchscreen surface by sensing a part of the finger (or stylus) that is within the threshold distance from the touchscreen and observing a gradual decrease in input signals as the finger is angled farther away from the touchscreen. If, for example, the self-capacitance touchscreen may only detect a portion of a finger that is 20 millimeters or closer to the screen, the point on the screen where the weakest signal is registered may be where the portion of the finger is 20 millimeters from the screen. The X and Y coordinates on the screen where that point is may be compared with the X and Y coordinates of where the fingertip, stylus, or other finger portion is contacting the screen. Based on the height of a point along the finger (e.g., 20 millimeters) and the distance between the point and the fingertip, using trigonometric relations, the angle of the finger relative to the plane of the touchscreen may be determined. Additionally, by determining the difference and direction between the X and Y coordinates of the point along the finger and the X and Y coordinates of the fingertip, the orientation of the finger (e.g., if the finger is coming from right-to-left or left-to-right) may be determined. Based on the determined angles of the finger, the finger may be determined to be from a left-hand or right-hand perspective.

Based on the determination of which finger is used, a system on the mobile device may perform different actions or interpret user interactions differently to adapt to the hand being used. For example, the system may adjust the layout of the UI (for the operating system or applications) to adapt to the determined usage mode, where the mode may be a right-hand mode or a left-hand mode. Alternatively, the system may automatically reorient the screen of the mobile device according to the detected direction of the finger. Other functions may also be performed based on the direction of the finger or the angles between the finger and touchscreen.

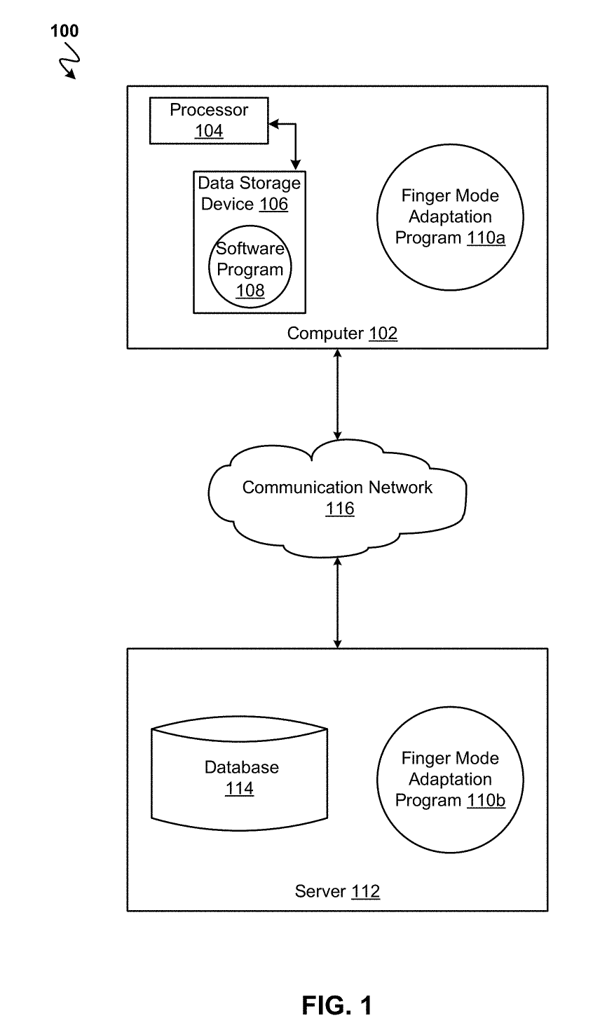

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a finger mode adaptation program 110a. The networked computer environment 100 may also include a server 112 that is enabled to run a finger mode adaptation program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

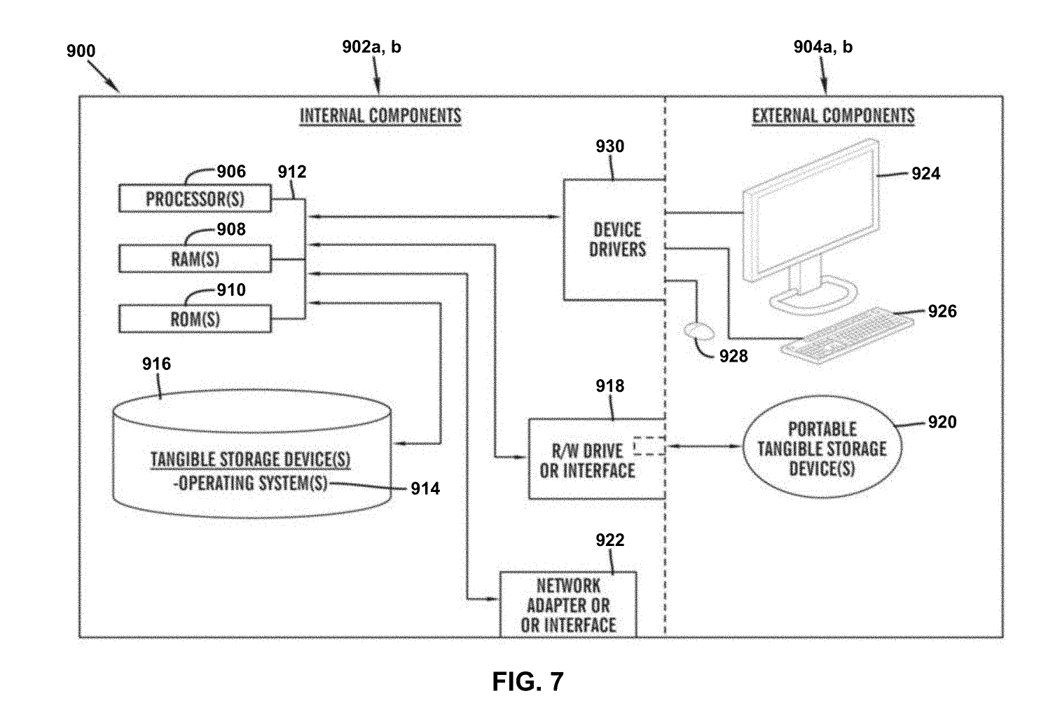

The client computer 102 may communicate with the server computer 112 via the communications network 116. The communications network 116 may include connections, such as wire, wireless communication links, or fiber optic cables. As will be discussed with reference to FIG. 7, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the finger mode adaptation program 110a, 110b may interact with a database 114 that may be embedded in various storage devices, such as, but not limited to a client computer 102, a networked server 112, or a cloud storage service.

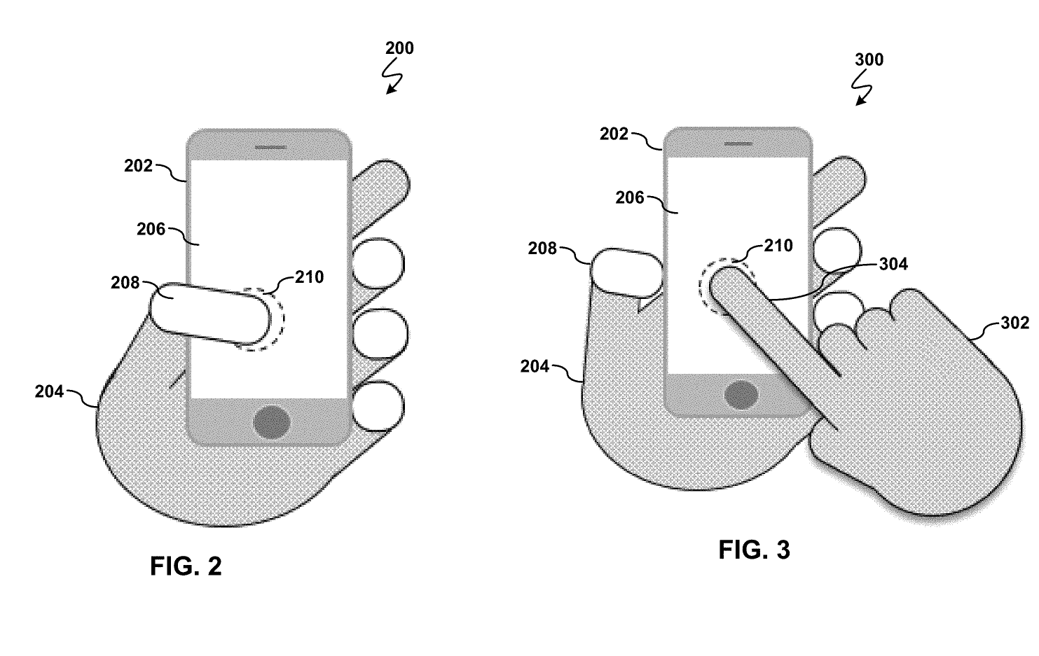

According to the present embodiment, a user using a client computer 102 or a server computer 112 may use the finger mode adaptation program 110a, 110b (respectively) to determine which hand is used to interact with a mobile device touchscreen and alter a UI based on that determination. The finger mode adaptation method is explained in more detail below with respect to FIGS. 2-6.

Referring now to FIG. 2, an example of single-handed operation 200 of a mobile device 202 using a left hand 204 for interaction is depicted. As shown, a person may use their left hand 204 to interact with the touchscreen 206 of the mobile device 202 (e.g., computer 102) while holding the mobile device 202 with their left hand 204 by using their left thumb 208. In the single-handed operation 200 depicted, the left thumb 208 extends left-to-right from the left side of the mobile device 202 over to the contact point 210 on the touchscreen 206 where the left thumb 208 touches the touchscreen 206.

Referring now to FIG. 3, an example of double-handed operation 300 of the mobile device 202 using a right hand 302 for interaction is depicted. As shown, a person may use their right hand 302 to interact with the touchscreen 206 of the mobile device 202 while holding the mobile device with their left hand 204. The person may interact with the mobile device's 202 touchscreen 206 using the right index finger 304 of the person's right hand 302. As shown, the right index finger 304 of the person may extend from the bottom-right of the mobile device 202 towards the upper-left of the mobile device 202 to the contact point 210 where the right index finger 304 touches the touchscreen 206.

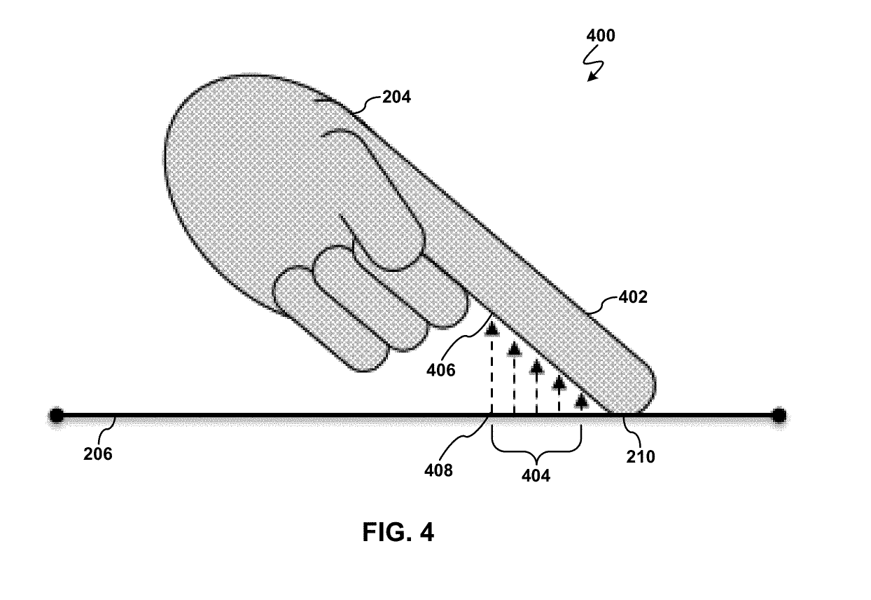

Referring now to FIG. 4, a side view of an angled single finger interaction 400 with a touchscreen 206 is depicted. A person may interact with the touchscreen 206 using the left index finger 402 of their left hand 204 to touch the touchscreen 206 at the contact point 210 as shown. Furthermore, when using a floating-capable touchscreen 206, additional detection points 404 where the left index finger 402 is not touching the touchscreen 206 and yet still is detectable by the touchscreen 206 may be determined. As shown, the additional detection points 404 may provide data that may be used to determine the angle of the left index finger 402 in relation to the touchscreen 206. In a scenario when the touchscreen 206 may provide varying signal strengths based on the distance to portions of the left index finger 402 for the additional detection points 404, the signal strength of the additional detection points 404 may be used to calculate a slope of the left index finger 402. Alternatively, if the maximum distance the touchscreen 206 may read is known, such as 20 millimeters from the touchscreen 206, then where the additional detection points 404 end may be the maximum detectable height point 406 where the left index finger 402 may be determined to be at a height of 20 millimeters above the touchscreen 206 (provided a screen edge is not encountered first and touchscreen detection capabilities end). Following the determination of the maximum detectable height point 406, the angle of the left index finger 402 may be determined using known trigonometric relationships based on the distance from the contact point 210 to the last detection point 408 along the touchscreen 206 surface where the maximum detectable height point 406 was detected.

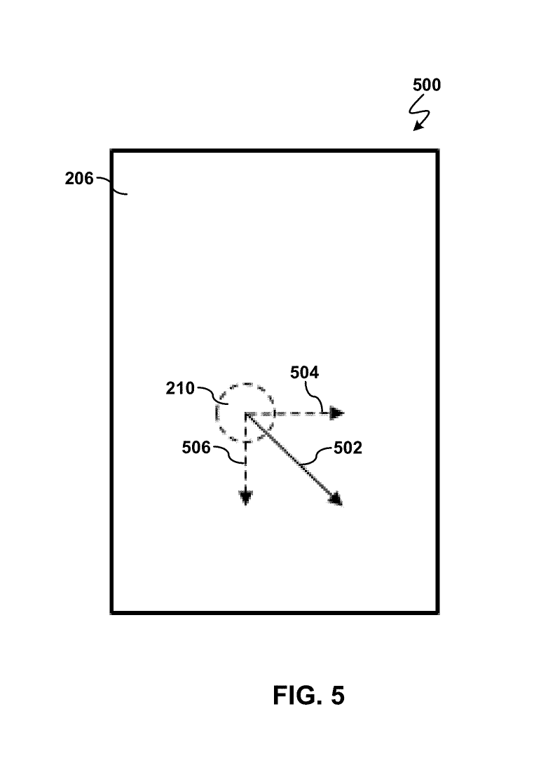

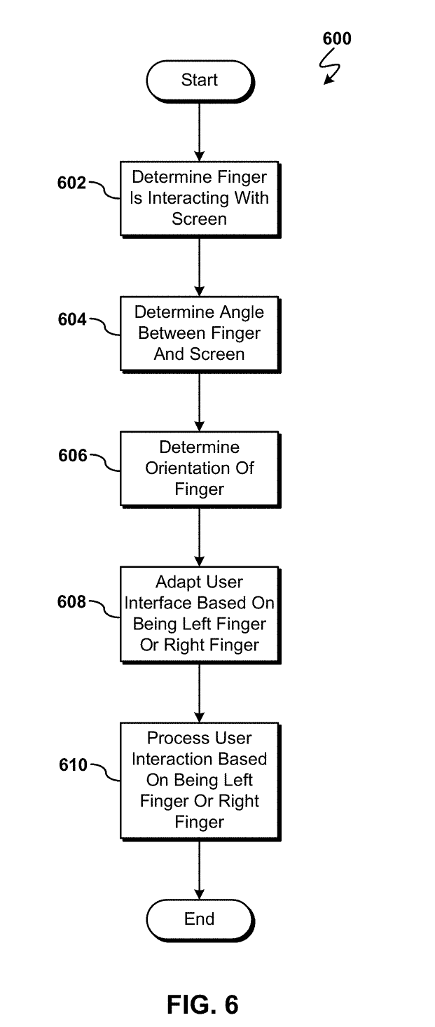

Referring now to FIG. 5, finger orientation detection 500 on a touchscreen 206 according to at least one embodiment is depicted. Finger orientation may be determined from comparing the X and Y coordinates of the contact point 210 (i.e., contact point coordinates) on the touchscreen 206 with the X and Y coordinates of one or more of the additional detection points 404 (i.e., additional detection point coordinates). As illustrated, the additional detection points 404 may result in a radial line 502 from the contact point 210 having an X distance 504 along the X axis and a Y distance 506 along the Y axis. Based on the X distance 504 and Y distance 506 the radial line 502 may be determined which corresponds with the orientation of a user finger touching the touchscreen 206. The radial line 502 depicted indicates that the user finger extends from the bottom-right of the touchscreen 206 towards the upper-left direction of the touchscreen 206 to the contact point 210. The bottom-right to upper-left finger orientation may be consistent with use of a right hand 302 as shown in the double-handed operation 300 illustrated in FIG. 3. Based on determining the finger orientation of a right hand 302, the UI of the mobile device 202 may be adapted into a right-hand mode to provide a more effective UI as will be discussed below in further detail with respect to FIG. 6.

Referring now to FIG. 6, an operational flowchart illustrating the exemplary adaptive user interface process 600 used by the finger mode adaptation program 110a and 110b according to at least one embodiment is depicted.

At 602, the finger mode adaptation program 110a and 110b determines that a finger (e.g., right index finger 304) is interacting with the touchscreen 206 of a mobile device 202. Known touchscreen 206 input detection methods may be used to determine that a finger is interacting with the touchscreen 206. For example, an interrupt may be generated, a particular memory address may be polled, or a system call may be used to determine that there was touchscreen 206 input. Furthermore, the determined interaction may indicate the contact point 210 where the finger touches the touchscreen 206. It may be appreciated that according to other embodiments, a substitute point may be determined instead of the contact point 210 if a finger or stylus has not contacted the touchscreen 206. The substitute point may be the point where the strongest signal is generated from the floating-capable touchscreen 206 indicating, for example, that the fingertip is closest to the touchscreen 206 at that point; however, the fingertip is not in contact with the touchscreen 206 yet. Thus, instead of finger interaction occurring when a finger touches the touchscreen 206, finger interaction with the touchscreen 206 may be determined when the finger produces a threshold signal from the touchscreen 206 (e.g., the finger is within a millimeter of the touchscreen 206).

Next, at 604, an angle between the user's finger and the touchscreen 206 is determined. As described previously with respect to FIG. 4, the angle between the user's finger and the surface of the touchscreen 206 may be determined using the contact point 210 and additional detection points 404. The determined finger angle may then be stored in a data repository, such as a database 114.

Then, at 606, the orientation of the user's finger is determined. As described previously with respect to FIG. 5, based on the X and Y coordinates of the additional detection points 404, the radial line 502 indicating the finger orientation may be determined. From the determined finger orientation, which hand (i.e., left hand 204 or right hand 302) is being used may be determined.

At 608, a UI is adapted based on the finger being from the user's left hand 204 or right hand 302. Once the hand that is used by the user to interact with the mobile device's 202 touchscreen 206 is determined at 606, then the UI of an operating system, application, and the like may be adapted to suit a left-handed mode, a right-handed mode, or some other mode (e.g., landscape or portrait). For example, a left-handed mode may rearrange certain UI elements, such as on-screen buttons, to be more optimally placed within the UI for someone using a left hand 204. Elements that may accidentally be activated may be moved to the right side of the UI displayed on touchscreen 206 since the user may not easily reach the right side of the UI while using a left hand 204. Additionally, more commonly used UI elements may be placed to the left side of the touchscreen 206 for quicker and easier activation by the user. According to at least one other embodiment, the screen display may be reoriented based on the determined finger orientation. For example, if the determined finger orientation is from a top-to-bottom orientation (when viewing the mobile device 202 from a portrait perspective), this finger orientation may indicate that the mobile device 202 is being used in a landscape orientation with the user holding the narrow sides of the mobile device 202. Thus, if the touchscreen 206 is displaying in portrait mode, the UI may be adapted by switching to landscape mode.

Then, at 610, user interaction is processed based on the finger being from the user's left hand 204 or right hand 302. Certain interactions, such as gestures, may be handled differently based on the hand being used for interaction. For example, a left-to-right finger swipe on the touchscreen 206 may trigger a page forward function within a web browser application in left-hand mode while the same left-to-right finger swipe may trigger a page backward function within a web browser application in right-hand mode. Furthermore, based on the finger angle determined previously at 604, the angle of the finger may produce different input values. For example, if using a pinching gesture with two fingers on the touchscreen is recognized as a screen zoom (or image magnification) input, then the finger angle may be determined and used to alter the rate of zooming that may occur. As such, if the fingers used to pinch zoom are at a shallow angle, the zoom rate may be less than if the fingers are at steep angle.

It may be appreciated that FIGS. 2-6 provide only an illustration of one embodiment and do not imply any limitations with regard to how different embodiments may be implemented. Many modifications to the depicted embodiment(s) may be made based on design and implementation requirements. For example, according to at least one other embodiment, determining an angle between the finger and the touchscreen 206 may be omitted if no UI adaptation or input processing uses such information. According to yet another embodiment, determining finger orientation may proceed without the finger touching the touchscreen 206. Using the floating detection of a floating-capable touchscreen 206, the orientation of the finger may be determined based on reading two or more points on the touchscreen 206 where the finger is in sufficiently close proximity to be read and thereafter the radial line 502 may be determined as described previously with respect to FIG. 5.

FIG. 7 is a block diagram 900 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 7. Each of the sets of internal components 902 a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the finger mode adaptation program 110a in client computer 102, and the finger mode adaptation program 110b in network server 112, may be stored on one or more computer-readable tangible storage devices 916 for execution by one or more processors 906 via one or more RAMs 908 (which typically include cache memory). In the embodiment illustrated in FIG. 7, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the finger mode adaptation program 110a and 110b, can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the finger mode adaptation program 110a in client computer 102 and the finger mode adaptation program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the finger mode adaptation program 110a in client computer 102 and the finger mode adaptation program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

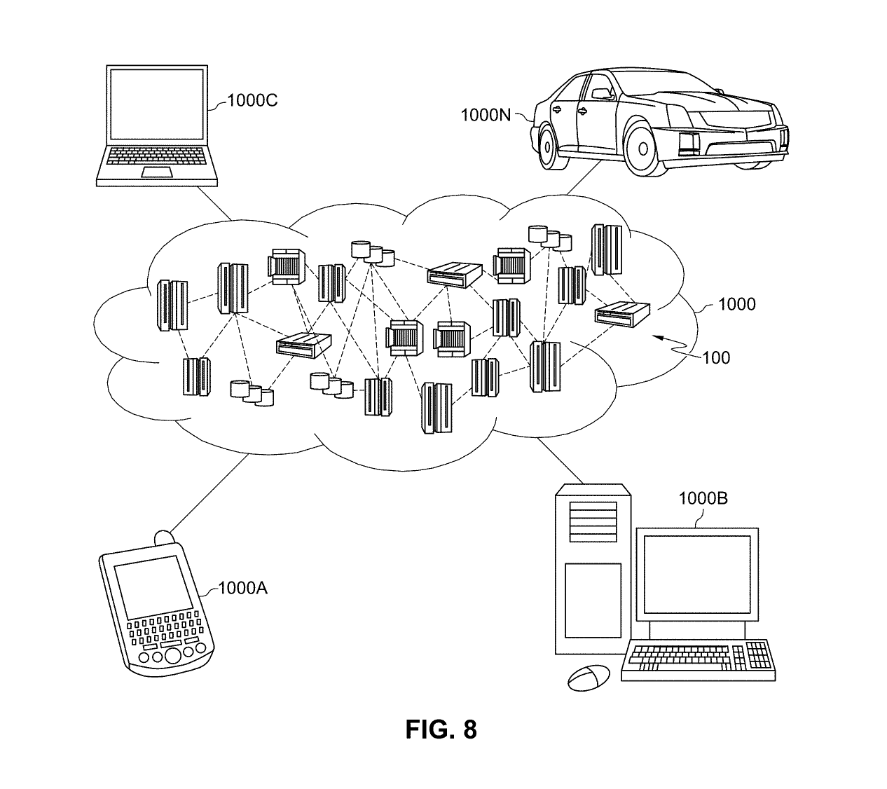

Referring now to FIG. 8, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 8 are intended to be illustrative only and that computing nodes 100 and cloud computing environment 1000 can communicate with any type of computerized device over any type of network and/or network addressable connection (e.g., using a web browser).

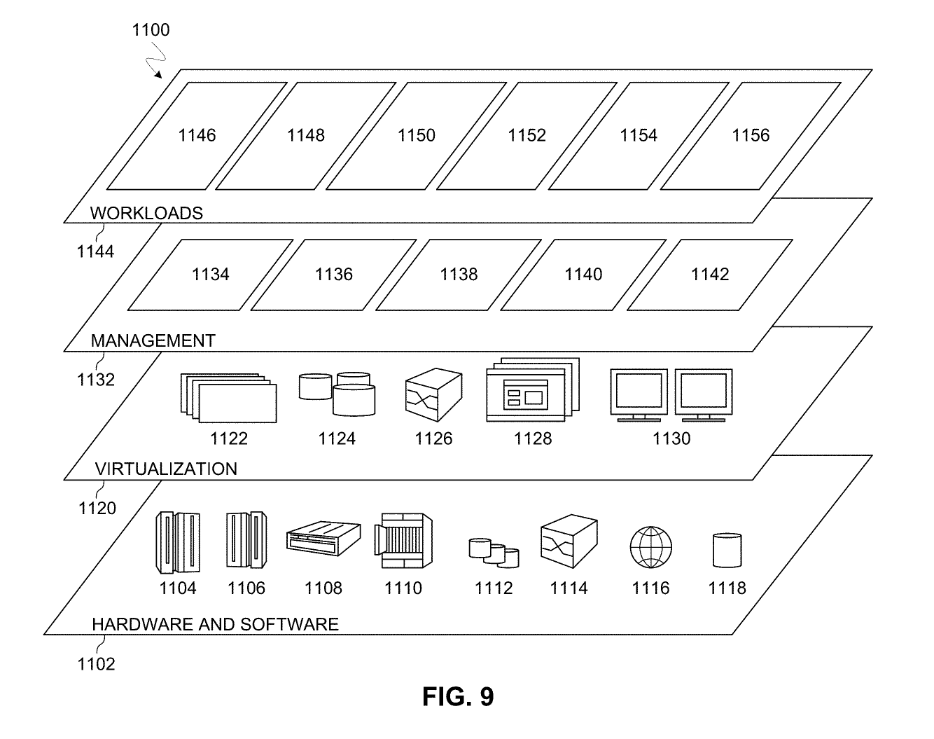

Referring now to FIG. 9, a set of functional abstraction layers 1100 provided by cloud computing environment 1000 is shown. It should be understood in advance that the components, layers, and functions shown in FIG. 9 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and finger mode adaptation 1156. A finger mode adaptation program 110a, 110b provides a way to determine which hand is used to interact with a mobile device touchscreen and alter a UI based on that determination.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for adapting a user interface (UI) with a touchscreen, the method comprising:
receiving, from the touchscreen, an input from a finger, wherein the touchscreen is a floating-capable touchscreen that will detect a portion of the finger that is not in contact with the touchscreen, wherein the received input from the finger comprises a contact point indicating where the finger contacts the touchscreen and a plurality of additional detection points, and wherein the detected portion includes the plurality of additional detection points associated with the touchscreen;
determining an orientation of the finger based on the received input and the plurality of additional detection points, wherein the determined orientation of the finger includes a left-hand mode associated with determining that the finger is on a left hand and a right-hand mode associated with determining that the finger is on a right hand;
determining a finger angle based on the received input and the plurality of additional detection points;
adapting the UI based on the determined finger angle and determined orientation of the finger, wherein adapting the UI based on the determined orientation comprises moving at least one UI element associated with the UI to a different position on the touchscreen;
displaying the adapted UI on the touchscreen;
receiving the input gesture in response to displaying the adapted UI; and
processing the received input gesture based on the determined finger angle, wherein the received input gesture is processed differently when in left-hand mode or right-hand mode.
